(19) United States
(12) Patent Application Publication
(10) Pub. No.: US 2026/0219961 A1
(43) Pub. Date: Jul. 30, 2026

(54) SYSTEM AND METHOD FOR MICRO-ARCHITECTURE AWARE TASK SCHEDULING

(71) Applicant: QUALCOMM Incorporated, San Diego, CA (US)

(72) Inventors: Yanwu Wang, Dongguan (CN); Ning Sun, Beijing (CN); Yongjun Dai, Shanghai (CN); Yigen Zhou, ShenZhen (CN); Yun Guo, Beijing (CN)

(21) Appl. No.: 19/144,848

(22) PCT Filed: Feb. 15, 2023
(86) PCT No.: PCT/CN2023/076126

§ 371 Date: Jun. 30, 2025

(51) Int. Cl. G06F 9/50

(52) U.S. Cl. CPC G06F 9/5094; G06F 2209/5019

(57) ABSTRACT

This disclosure provides systems, methods, and devices for task assignment in a processor. In a first aspect, a method for assigning a task for execution by a processor includes calculating a first stall parameter for the task associated with a first central processing unit (CPU) of the processor, wherein the task is assigned to the first CPU of the processor, calculating a second stall parameter for the task associated with a second CPU of the processor, and assigning the task to the second CPU based on the first stall parameter and the second stall parameter. Other aspects and features are also claimed and described.

### TECHNICAL FIELD

Aspects of the present disclosure relate generally to processors, and more particularly, to methods and systems suitable for scheduling processing tasks across a plurality of CPUs of a processor.

### INTRODUCTION

Processors may be included in a variety of devices, such as wireless communications devices, personal computing devices, smart vehicles, camera devices, and other devices, and may be configured to execute a variety of computing tasks. For example, processors may be configured to execute image processing tasks, calculation tasks, gaming tasks, graphics processing tasks, and other tasks. Some processors may include multiple central processing units (CPUs). Some processors may include multiple clusters of CPUs, also referred to as cores, with each cluster including one or more CPUs. Different clusters, and different CPUs within a same cluster, may be allocated different resources, such as different cache sizes.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Tasks may be reassigned from a first CPU of a processor to a second CPU of the processor based on a number of stalls that occur during a time period while the task is being executed by the first CPU of the processor. Different CPUs of a processor may, for example, be assigned different resources and/or may operate with different performance levels in the front end or back end. Thus, tasks that require more front end resources, for example, may be executed with fewer stalls on a CPU allocated more resources for better front end performance than one or more other CPUs of the processor. Efficiency in execution of tasks by the processor may be enhanced by monitoring a number of stalls when a task is executed by a first CPU of the processor, calculating a number of stalls if the task were executed by one or more other CPUs of the processor, or other stall parameter related to a predicted stall rate if the task were executed by one or more other CPUs, and assigning the task to a CPU with a lower predicted number of stalls, or other stall parameter of another CPU, than the measured number of stalls when the task is executed by the first CPU, or other stall parameter of the first CPU. As one particular example, such efficiency enhancement may enhance execution of gaming applications by a device, providing increased framerate and responsiveness, reduced power consumption, and other advantages.

In one aspect of the disclosure, a method for assigning a task for execution by a processor includes calculating a first stall parameter for the task associated with a first CPU of the processor, wherein the task is assigned to the first CPU of the processor, calculating a second stall parameter for the task associated with a second CPU of the processor, and assigning the task to the second CPU based on the first stall parameter and the second stall parameter.

In an additional aspect of the disclosure, an apparatus includes a memory storing processor-readable code and at least one processor coupled to the memory. The at least one processor is configured to execute the processor-readable code to cause the at least one processor to perform operations including calculating a first stall parameter for a task associated with a first CPU of the processor, wherein the task is assigned to the first CPU of the processor, calculating a second stall parameter for the task associated with a second CPU of the processor, and assigning the task to the second CPU based on the first stall parameter and the second stall parameter.

In an additional aspect of the disclosure, an apparatus means for calculating a first stall parameter for a task associated with a first central processing unit (CPU) of a processor, wherein the task is assigned to the first CPU of the processor, means for calculating a second stall parameter for the task associated with a second CPU of the processor, and means for assigning the task to the second CPU based on the first stall parameter and the second stall parameter.

In an additional aspect of the disclosure, a non-transitory computer-readable medium stores instructions that, when executed by a processor, cause the processor to perform operations. The operations include calculating a first stall parameter for a task associated with a first central processing unit (CPU) of the processor, wherein the task is assigned to the first CPU of the processor, calculating a second stall parameter for the task associated with a second CPU of the processor, and assigning the task to the second CPU based on the first stall parameter and the second stall parameter.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram of an example CPU according to one or more aspects of the disclosure.

FIG. 2 is a block diagram of task assignment functionality for a processor according to one or more aspects of the disclosure.

FIG. 3 is a block diagram of an organization of CPU clusters of a processor according to one or more aspects of the disclosure.

FIG. 4 is a flow chart illustrating an example method for task assignment in a processor based on power consumption according to one or more aspects of the disclosure.

FIG. 5 is an example power profile of a CPU according to one or more aspects of the disclosure.

FIG. 6 is an example table of pipeline capacities for a plurality of pipeline components of a plurality of CPUs according to one or more aspects of the disclosure.

FIG. 7 is an example graph of a number of stalls for a processor executing different tasks according to one or more aspects of the disclosure.

FIG. 8 is a flow chart illustrating an example method for micro-architecture aware task scheduling according to one or more aspects of the disclosure.

FIG. 9 is a flow chart illustrating an example method for micro-architecture aware task scheduling according to one or more aspects of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support micro-architecture aware task scheduling in a processor. Tasks may be reassigned from a first CPU of a processor to a second CPU of the processor based on a number of stalls that occur during a time period while the task is being executed by the first CPU of the processor. A number of stalls that may occur when a task is executed by a processor may be related to a microarchitecture of the processor. Different CPUs of a processor may, for example, be assigned different resources and/or may operate with different performance levels in the front end or back end. Thus, tasks that require more front end resources, for example, may be executed with fewer stalls by a CPU allocated more resources for better front end performance than one or more other CPUs of the processor.

Particular implementations of the subject matter described in this disclosure may be implemented to realize one or more of the following potential advantages or benefits. In some aspects, the present disclosure provides techniques for task assignment that may be particularly advantageous in gaming applications. For example, efficiency in execution of tasks by the processor may be enhanced by monitoring a number of stalls when a task is executed by a first CPU of the processor, calculating a number of stalls if the task were executed by one or more other CPUs of the processor, and assigning the task to a CPU with a lower predicted number of stalls than the measured number of stalls when the task is executed by the first CPU. In particular, reassignment of tasks to CPUs that are predicted to encounter fewer stalls may reduce a number of stalls encountered. Such a reduction may enhance computing efficiency and reduce power consumption. As one particular example, such efficiency enhancement may enhance execution of gaming applications by a device, providing increased framerate and responsiveness, reduced power consumption, and other advantages.

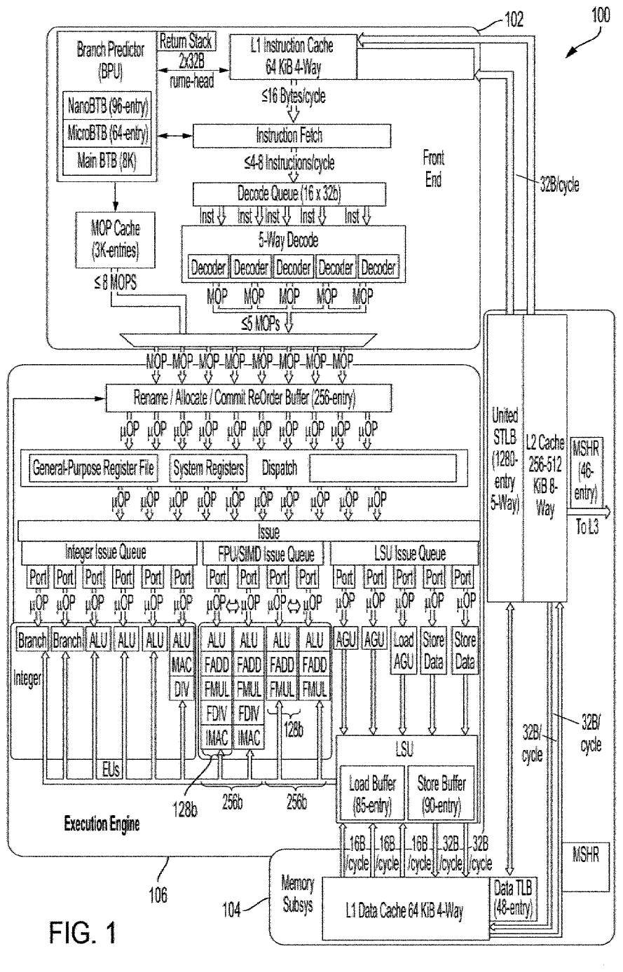

An example CPU 100 is shown in FIG. 1. The CPU 100 may be an example ARMv8 CPU and may be integrated in a system on chip (SOC) form factor. A front end 102 of the CPU 100 may include an L1 instruction cache, a macro-OP (MOP) cache, a branch predictor unit, an instruction fetch module, an instruction translation lookaside buffer (TLB), a decode queue, a 5-way decoder, and other components. A memory subsystem 104 may interact with a front end 102 or a back end 106 of the CPU and may include an L2 cache, an L1 data cache, and other components. In some embodiments, a memory subsystem 104 may be considered part of a front end 102 or a back end 106 of the CPU. For example, in some embodiments, an L2 cache of the memory subsystem 104 may interact with a front end 102 of the CPU 100 and a back end 106 of the CPU, while an L1 data cache may interact with a back-end 106 of the CPU 100. The back end 106 of the CPU may be referred to as an execution engine, and may include a rename/allocate/commit/reorder buffer, a dispatch module, one or more queues, one or more branch units, one or more arithmetic logic units (ALUs), one or more address generation units (AGUs), one or more data store units, a load-store unit (LSU), and one or more other components. In some cases multiple CPUs 100 may be included in a processor. Some CPUs included in a processor may have a different MOP cache size, a different L1 cache size, a different L2 cache size, and a different L3 cache size. Furthermore, different CPUs may have different sizes of fetch modules, decode queues, ld_st numbers, and tlb_entry numbers. In particular, different CPUs 100 of a processor may be designed with different cache, buffer sizes, and other parameters to achieve different performance and power consumption characteristics. Such design may be heavily tuned towards benchmark tests.

In some embodiments, some CPUs may be tuned for enhanced front-end 102 performance, while other CPUs may be tuned for enhanced back end 106 performance. Different tasks, when sent to the CPU 100, such as different operations to be performed when executing different applications, may require different front end resources and back end resources. When insufficient resources are available to complete a task in a cycle, a stall may occur, delaying completion of the task. For example, in some scenarios a CPU front end 102 may fetch multiple instructions at each cycle and may push such instructions to the back end 106 for execution. Such a CPU pipeline may allow for instruction-level parallelism. When insufficient resources are available in a given cycle to fetch and/or perform a fetched task, a stall may occur, as the CPU may be required to wait for resource availability to fetch or perform the task. Such stalls may reduce the benefits of parallelism, which may lead to reduced execution efficiency. Some tasks may be more likely to encounter stalls at a front end 102 of a CPU 100, while other tasks may be more likely to encounter stalls at a back end 106 of a CPU 100. A greater number of stalls may result in greater CPU active time, requiring more time to complete a task and resulting in increased power consumption. Such stalls may negatively impact performance of a device, such as decreasing a frame rate of a gaming application and/or reducing battery life.

A number of stalls of a CPU, such as CPU 100 of FIG. 1, may be counted using one or more top-down performance monitoring unit (PMU) counters. Stalls may, for example, occur in a front end 102 of a CPU 100. Stalls that occur associated with or in a front end 102 of a CPU 100 may include memory-bound stalls, such as stalls that occur associated with or in an L1 instruction cache, an L2 cache, a front end memory, or a front-end TLB, and CPU-bound stalls, such as stalls that occur associated with a flow function of the front end 102 or a rename function of the front end 102. Likewise, stalls that occur associated with or in a back end 106 of a CPU 100 may include memory-bound stalls, such as stalls that occur associated with or in an L1 data cache, an L2 cache, a back end memory, or a back end TLB, and CPU-bound stalls, such as stalls that occur associated with a busy function of the back end, an ilock function of the back end, or a rename function of the back end. Such stalls may be monitored by one or more PMUs to determine a total number of front end stalls and a total number of back end stalls that occur during a period of time when a task is executed by the CPU 100. Other stalls may include bad speculation stalls and retired-bound stalls. In some embodiments, stalls may be monitored and counted for individual pipeline components of the CPU 100, as discussed herein.

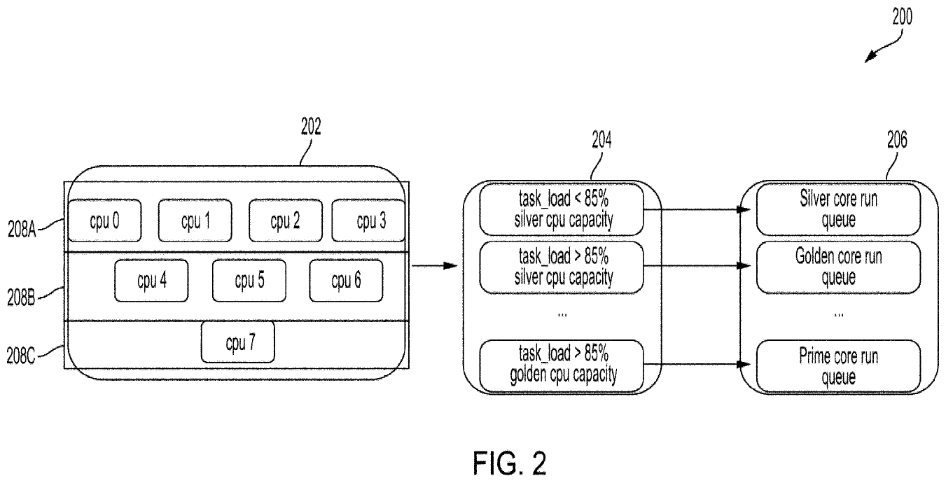

Multiple CPUs may be included in a processor, and such CPUs may be organized into CPU clusters, also referred to as cores. An example diagram 200, of task assignment to a plurality of CPUs of a plurality of clusters 208A-C of a processor 202 is shown in FIG. 2. A first cluster 208A may be referred to as a silver CPU cluster and may include four CPUs. A second cluster 208B may be referred to as a gold CPU cluster and may include three CPUs. A third cluster 208C may be referred to as a prime CPU cluster and may include one CPU. In some embodiments, a processor may have fewer or more CPUs in fewer or more clusters than shown in the processor 202. The CPU of the prime cluster 208C may have greater capacity and synthetic power performance than each of the CPUs of the gold cluster 208B, which may have greater capacity and synthetic power performance than each of the CPUs of the silver cluster 208A. Tasks may be assigned to the clusters 208A-C based on a task load of each cluster. In particular, if a task load of a certain cluster, such as the silver cluster 208A, exceeds a predetermined threshold, a task may be assigned to a higher ranked cluster, such as the gold cluster 208B. For example, a scheduler 204 may assign tasks to the CPU clusters 208A-C based on a task load that would be placed on each respective CPU cluster if the task were to be assigned to each respective CPU cluster. In some embodiments, a task may be assigned to a cluster of a plurality of clusters based on current task loads on each of the plurality the clusters, without taking into account any changes to the task loads that may be caused by addition of the task to a run queue for the cluster.

As one example, if a task load is lower than 85% of the silver CPU cluster 208A capacity, the task may be assigned, by the scheduler 204, to the silver cluster 208A and may be queued by task placement module 206 in a silver core run queue. Similarly, if a task load is greater than 85% of the silver CPU cluster 208A capacity, but less than 85% of a gold CPU cluster 208B capacity, the task may be assigned, by the scheduler 204, to the gold cluster 208B and may be queued by task placement module 206 in a gold core run queue. Likewise, if a task load is greater than 85% of a gold CPU cluster 208B capacity, the task may be assigned, by the scheduler 204, to the prime cluster 208C and may be queued by task placement module 206 in a prime core run queue. Thus, tasks may be assigned to be executed by a CPU of a particular cluster based on task load. In some cases, task assignment may also be based on affinity, CPU utilization, and load balance, in addition to a predicted task load.

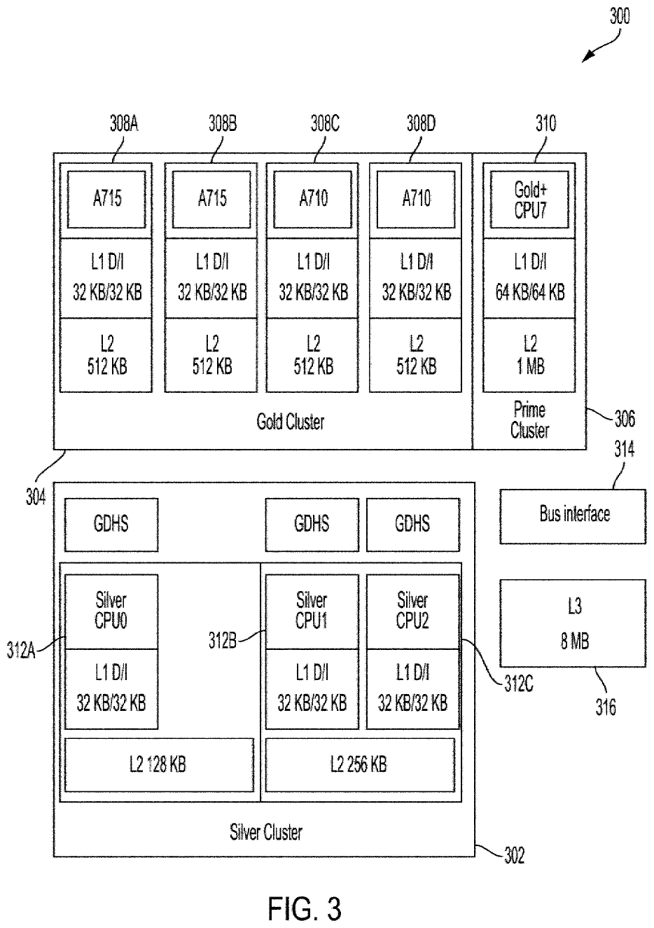

Different CPU clusters may have different resources, such as different amounts of L1 and L2 memory, different reorder buffer (ROB) sizes, and different MOP sizes, for completing tasks. Furthermore, different CPUs within a particular cluster may have different resources, such as different amounts of L1 and L2 memory, different ROB sizes, and different MOP sizes, for completing tasks. An example processor 300 of FIG. 3 may include a prime CPU cluster 306, a gold CPU cluster 304, and a silver CPU cluster 302. The prime CPU cluster 306 may include a first CPU 310 assigned 64 kB of L1 data and instruction cache memory and 1 MB of L2 memory. The gold CPU cluster 304 may include a first CPU 308A, a second CPU 308B, a third CPU 308C, and a fourth CPU 308D, with each CPU being assigned 32 kB of L1 data and instruction cache memory and 512 kB of L2 memory. The silver CPU cluster 302 may include a first CPU 312A having 32 kB of L1 data and instruction cache memory and 128 kB of L2 memory. The silver CPU cluster 302 may also include a second CPU 312B and a third CPU 312C having 32 kB of L1 data and instruction cache memory and 256 kB of L2 memory. Thus, the second and third CPUs 312B-C may be allocated a greater amount of L2 memory than the first CPU 312A of the silver CPU cluster 302. The processor 300 may also include a bus interface 314 and an L3 memory with a capacity of 8 MB, for use by the CPUs 310, 308A-D, 312A-C. The processor 300 may further include one or more global distributed head switches (GDHSs).

As one particular example, different CPUs of the processor 300 may operate with different stall rates, whether or not the CPUs are assigned a same amount of memory. For example, the first and second CPUs 308A-B of the gold cluster 304 may be of a first type, while the third and fourth CPUs 308C-D of the gold cluster 304 may be of a second type. For example, the first and second CPUs 308A-B may lack a MOP cache, while the third and fourth CPUs 308C-D may have a stronger load data/store data (LD/SD) performance and/or superior memory access. The first and second CPUs 308A-B may have a higher front end stall rate and a higher bad speculation stall rate, while the third and fourth CPUs 308A-B may have a higher back end stall rate. Thus, if a scheduler assigns tasks to CPUs of a cluster based only on power consumption, and does not take into account other performance characteristics, such as a number of stalls, of the different CPUs of the cluster, more stalls may occur when executing tasks than if the scheduler assigns the tasks based on a predicted number of stalls for each of the CPUs of the cluster.

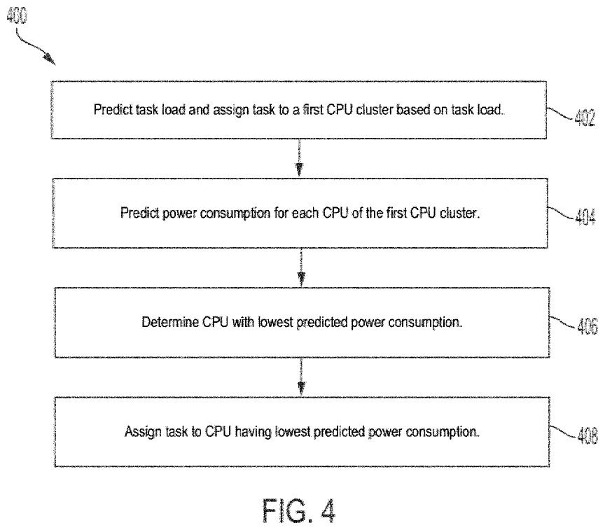

CPUs of a processor, such as processor 300 of FIG. 3, that are in a same cluster may be treated as having the same characteristics, even when characteristics, such as amounts of memory assigned to the CPUs, differ within the cluster. An example method 400 for assignment of tasks to be performed by CPUs of a processor is shown in the flow chart of FIG. 4. The method 400 may include, at block 402, predicting a task load and assigning a task to a first CPU cluster based on the task load. For example, a device, such as a processor, may predict task loads that a particular task, such as a task of a gaming application, may place on CPUs of different clusters if assigned to the clusters, as described with respect to FIG. 2. In making such a prediction, the device may treat CPUs within a cluster as having the same characteristics, such as the same amounts of assigned resources, even when such CPUs are assigned different resources, such as described with respect to FIG. 3. Based on the predicted task loads, the task may be assigned to a first CPU cluster. For example, the task may be assigned to a silver CPU cluster, a gold CPU cluster, or a prime CPU cluster, as described with respect to FIG. 2.

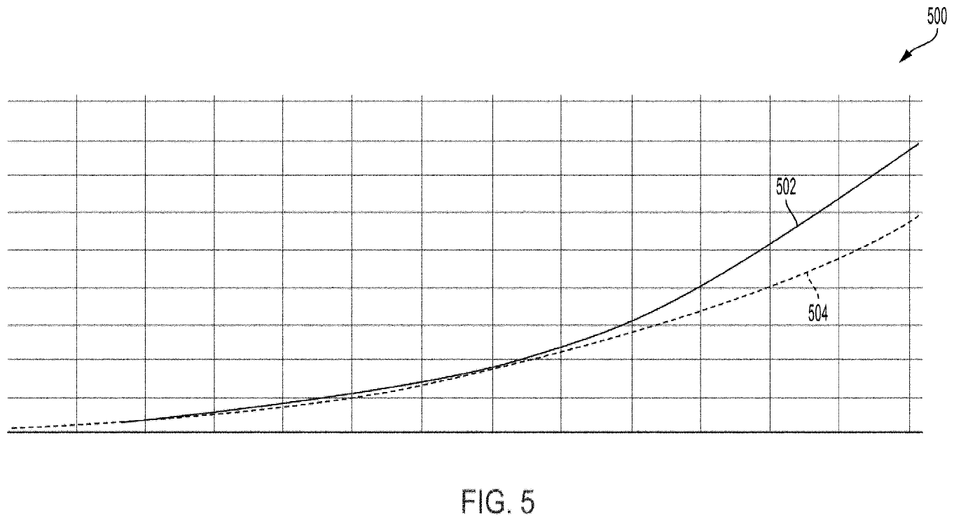

At block 404, the device may predict power consumption for each CPU of the first CPU cluster if the task were to be performed by each respective CPU. For example, the device may multiply a power optimization curve by the quotient of a utilization of each CPU of the cluster and a capacity of each CPU of the cluster. The graph 500 of FIG. 5 shows example power optimization curves 502, 504 for two different CPUs. Power optimization curves 502, 504 may represent different power consumption of two different CPUs based on operational frequencies of the CPUs. In particular, the x-axis of the graph 500 may represent a CPU operation frequency and the y-axis may represent a power of the CPU. An increase in task load placed on a CPU, will cause an increase in CPU operational frequency. An increase in CPU operation frequency will cause an increase in power consumption by the CPU. As the operational frequency increases to the right, the power usage of each CPU also increases. Thus, a power consumption value of a power optimization curve for a CPU, such as curve 502, at a particular utilization may be multiplied by a quotient of a utilization of the CPU and a capacity of the CPU to determine a predicted power consumption of the CPU. The power optimization curves 502, 504 of FIG. 5 may, however, represent power consumed when a synthetic workload is placed on CPUs. Different usage, stalls, and waste cycles in implementation of real world tasks, rather than under a synthetic workload such as a benchmark program, may result in power consumption that differs from a power optimization curve produced using a synthetic workload.

At block 406, the device may determine a CPU having a lowest predicted power consumption. For example, the values predicted for each CPU at block 404 may be compared to determine a CPU having a lowest predicted power consumption.

At block 408, the device, such as a task scheduler of the device, may assign the task to the CPU having the lowest predicted power consumption. Thus, the task may be assigned to the CPU of the cluster to which the task is assigned at block 402 having the lowest predicted power consumption, and the CPU may execute the task.

Assigning tasks based on task load and power consumption, as described with respect to FIG. 4, may, however, result in inefficiency. For example, even if a task encounters a large number of stall cycles, such as 80% stall cycles, and a high cache miss rate when the task is assigned to a prime CPU cluster, such a task may, according to the method 400 of FIG. 4, be and remain assigned to a prime CPU cluster. Such a task may, however, cause a CPU of the prime CPU cluster to operate at a higher frequency and consume a higher amount of power. Furthermore, assignment of such a task to a prime CPU cluster may monopolize prime CPU cluster resources that could be utilized to perform other tasks with greater efficiency. Thus, efficiency, power consumption, and performance may be enhanced by assigning such a task to a gold or silver CPU cluster based on the high number of stalls that will occur if the task is assigned to a prime CPU cluster.

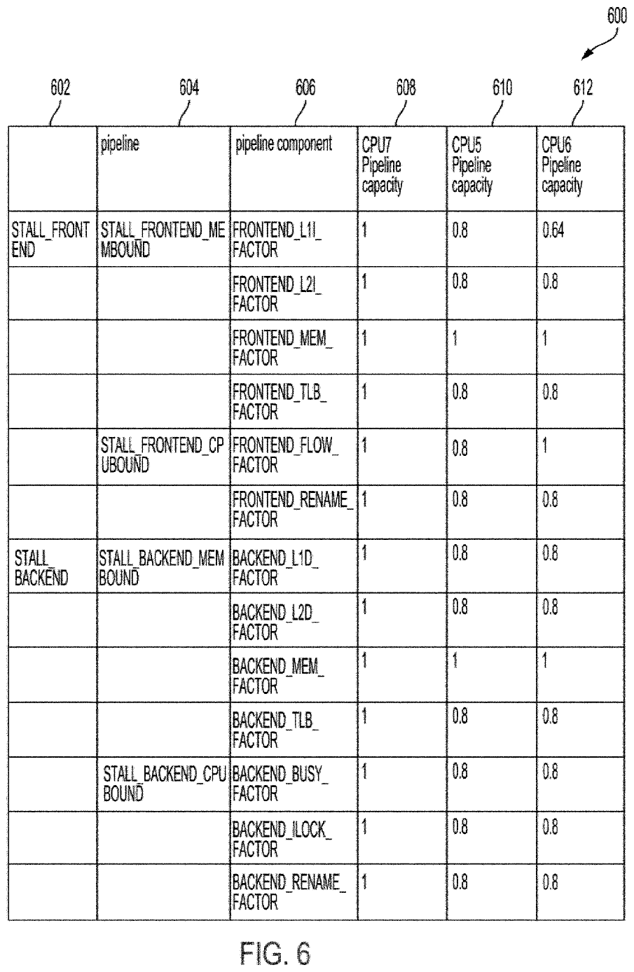

In order to enhance efficiency in execution of tasks, a task may be assigned to a CPU based on stall parameters of the task associated with CPUs of a cluster to which the task is assigned and/or CPUs of other clusters. For example, a number of stalls when a task is executed by a first CPU may be monitored and used to calculate a normalized stall percent value for the first CPU. In particular, the number of stalls may be multiplied by a normalized pipeline capacity value as described herein to generate a normalized stall percent value. The normalized stall percent value may be compared with predicted normalized stall percent values for other CPUs of a same cluster as the CPU and/or of different clusters, and a CPU with a lowest predicted stall percent value may be selected for execution of the task. Pipeline capacity values may be determined for CPUs of a processor for use in determining normalized stall percent values. An example table 600 showing calculated normalized pipeline capacities for a plurality of pipeline components of a plurality of CPUs of a processor is shown in FIG. 6. A first column 602 may include a list of CPU sections, such as front end and back-end. A second column 604 may include a list of pipelines for each section. A third column 606 may include a list of components for each pipeline. A fourth column 608 may include pipeline capacity values determined for a first CPU for each pipeline component. A fifth column 610 may include pipeline capacity values determined for a second CPU for each pipeline component. A sixth column 612 may include pipeline capacity values determined for a third CPU for each pipeline component. In some embodiments additional pipeline capacity values may be determined for additional CPUs and/or additional pipeline components. Pipeline capacity values may be normalized based on a CPU determined to have a best performance. For example, a CPU determined to have a best performance, such as a CPU of a prime cluster, may be given a pipeline capacity value of 1, while all other CPUs may be given normalized pipeline capacity values in relation to the pipeline capacity of the best CPU. Thus, for example, if the CPU of column 608 is a CPU having a best performance, pipeline capacity values of the other CPUs, such as CPUs of columns 610 and 612, may represent a pipeline capacity of the other CPUs as a percentage of the pipeline capacity of the CPU having the best performance. To determine pipeline capacity values of CPUs of a processor, the processor may execute a synthetic power case, such as a benchmark program, and may use one or more PMU counters to measure a number of stalls that occur on all CPUs. In some embodiments, the measured number of stalls that occur on all CPUs may be determined with further granularity, such as by determining a number of stalls that occur associated with each pipeline component of each CPU when running the benchmark program. A CPU having a best performance, such as a lowest number of stalls, may be determined based on the measured numbers of stalls, and the measured numbers of stalls for each CPU, or for each respective pipeline of each CPU, may be compared with the number of stalls for the CPU, or the respective pipeline component, having the best performance to determine a percentage pipeline capacity value for each CPU and/or for each pipeline component of each CPU. Thus, a normalized pipeline capacity value for each pipeline component of each CPU of a processor may be determined, and the CPU having the best performance may be assigned a CPU pipeline capacity value of 1.

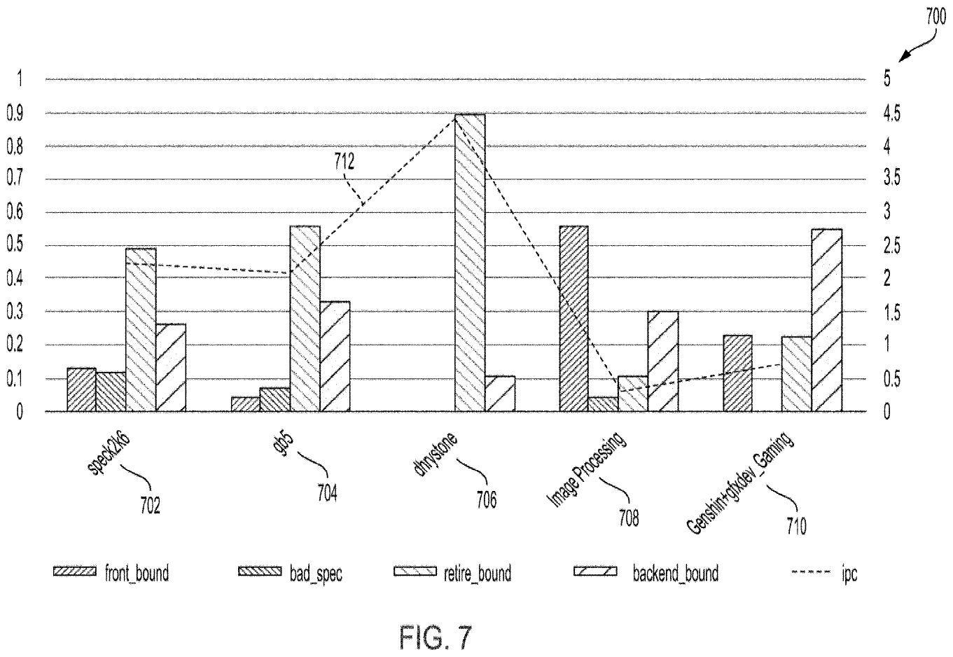

An example graph 700 of a number of instructions per cycle (IPC) for a processor when executing a variety of different tasks is shown in FIG. 7. Higher front_bound and backend_bound values may represent a greater number of stalls and/or wasted CPU cycles. When a first benchmark, such as speck2k6 702 is run, front end stalls, bad specification stalls, and back end bound stalls may be relatively low, while retire bound tasks may be high, producing a high IPC of around 2.4. When a second benchmark, such as gb5 704 is run, front end stalls, bad specification stalls, and back end bound stalls may be relatively low, while retire bound tasks may be high, producing a high IPC of around 2.1. When a third benchmark, such as dhrystone 706 is run, front end stalls and bad specification stalls may be at zero and back end bound stalls may be relatively low, while retire bound tasks may be high, producing a high IPC of around 4.5. Such benchmark values may, however, differ substantially from performance of a processor when executing tasks from real-world applications. For example, when an image processing application 708 is run, front end bound and back end bound stalls may be relatively high, while retire bound tasks may be low, producing a low IPC of around 0.3. Likewise, when a gaming application 710 is run, front end bound and back end bound stalls may be relatively high, while retire bound tasks may be low, producing a low IPC of around 0.7. Thus, benchmark tests used to tune performance of CPUs of a processor, such as benchmarks 702-706, may not be accurate in predicting performance of CPUs under real workloads, such as workloads 708-710.

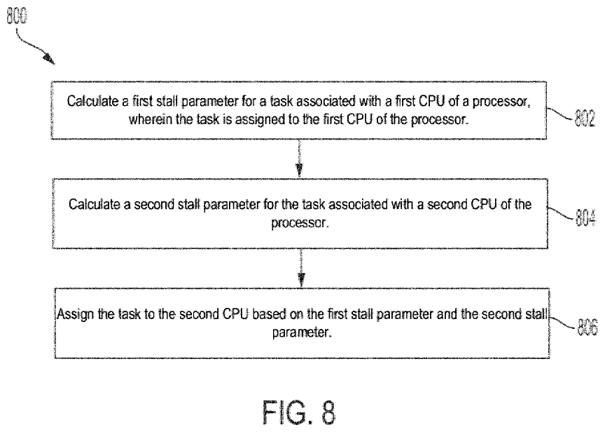

One method of micro-architecture aware task scheduling described herein is shown in FIG. 8. FIG. 8 is a flow chart illustrating an example method 800 for micro-architecture aware task scheduling. The method 800 includes, at block 802, calculating a first stall parameter for a task associated with a first CPU of a processor, wherein the task is assigned to the first CPU of a processor. The task may, for example, be a task associated with an application executed by the processor, such as a task of the gaming application. The first stall parameter may, for example, be a normalized stall percent value, a number of stalls that occur during a period of time when the task is executed by the first CPU, or another stall parameter. In some embodiments, calculating the first stall parameter may include calculating stall parameters for each of a plurality of pipeline components of the first CPU as described herein. In some embodiments, calculating the first stall parameter may include measuring a first number of stalls for a first time period while the task is being executed by the first CPU and multiplying the first number of stalls by a first normalized pipeline capacity of the first CPU, as described herein. In some embodiments, calculating the first stall parameter may include measuring numbers of stalls for a plurality of pipeline components of the first CPU, multiplying the numbers of stalls by respective pipeline capacities for the pipeline components, and summing the products of the numbers of stalls and the respective pipeline capacities. Such a sum may be referred to as a stall percent value of the first CPU. As one particular example, measuring numbers of stalls for a plurality of pipeline components of the first CPU may include measuring a number of stalls associated with a front end of the first CPU and measuring a number of stalls associated with a back end of the first CPU. In some embodiments, calculating the first stall parameter may further include multiplying a power curve parameter of the first CPU by the product of the first number of stalls and the first pipeline capacity of the first CPU, or multiplying the power curve parameter of the first CPU by a sum of the products of the numbers of stalls of the pipeline components and the pipeline capacities of the pipeline components of the first CPU. Thus, a first stall parameter of a first CPU executing the task may be determined based on a number of stalls that occur during a threshold period of time while the task is being executed by the first CPU, or a plurality of numbers of stalls that occur during a threshold period of time while the task is being executed by the first CPU associated with a plurality of pipeline components of the first CPU, a normalized pipeline capacity of the first CPU, or a plurality of normalized pipeline capacities of a plurality of pipeline components of the first CPU, and/or a power curve parameter of the first CPU.

At block 804, a second stall parameter for the task may be calculated, associated with a second CPU of the processor. The second stall parameter may, for example, be a normalized stall percent value, a number of stalls predicted to occur during a period of time if the task were executed by the second CPU, or another stall parameter. In some embodiments, calculating the second stall parameter may include calculating stall parameters for each of a plurality of pipeline components of the second CPU as described herein. In some embodiments, calculating the second stall parameter may include multiplying the first number of stalls, determined at block 802, with a pipeline capacity value, such as a normalized pipeline capacity value, of the second CPU, as described herein. In some embodiments, calculating the second stall parameter may include multiplying first numbers of stalls for a plurality of pipeline components of the first CPU with respective pipeline capacities, such as normalized pipeline capacity values, for pipeline components of the second CPU, and summing the products of the first number of stalls and the respective pipeline capacities. Such a sum may be referred to as a stall percent value of the first CPU. In some embodiments, calculating the second stall parameter may further include multiplying a power curve parameter of the second CPU by the product of the first number of stalls and the first pipeline capacity of the second CPU, or multiplying the power curve parameter of the second CPU by the sum of the products of the numbers of stalls of the pipeline components of the first CPU and the respective normalized pipeline capacities of the pipeline components of the second CPU.

In some embodiments, the first CPU and the second CPU may be in a same cluster, while in other embodiments, the first CPU and the second CPU may be in different clusters. For example, first and second power curve parameters may be used to determine the first and second stall parameters when the first CPU and the second CPU are in different clusters and/or a default CPU selection mode is selected, as CPUs of different clusters may have power performances that vary to a greater degree than CPUs of a same cluster. In some embodiments, first and second power curve parameters may not be used to determine the first and second stall parameters, even when the second CPU is in a different cluster from the first CPU, when a performance CPU selection mode is selected. In some embodiments, stall parameters for additional CPUs may be determined. For example, stall parameters for all CPUs of a processor may be determined or stall parameters for all eligible CPUs of a processor may be determined. Thus, in some embodiments, a processor may determine which CPUs are eligible CPUs before determining stall parameters of the respective eligible CPUs.

At block 806, the task may be assigned to the second CPU based on the first stall parameter and the second stall parameter. For example, the processor may determine that the stall parameter of the second CPU, such as the stall percent of the second CPU, has a lower value than the stall parameter of the first CPU, such as the stall percent of the first CPU, and may determine to transfer the task to the second CPU based on the determination. In some embodiments, stall parameters, such as stall percentages, of multiple CPUs may be compared, and a CPU having a lowest stall parameter value may be determined. The task may be assigned to the CPU having the lowest stall parameter value. In some embodiments, such as when stall parameters are determined based on power curve parameters for CPUs in different clusters, the task may be assigned to the second CPU based on the power curve parameters of the first, second, and other CPUs in addition to being based on the normalized pipeline capacities of the CPUs and the measured number of stalls when the task is executed on the first CPU. For example, if a default mode is selected, the first stall parameter may be determined by multiplying a first number of stalls of the first CPU with a pipeline capacity value of the first CPU and a power curve parameter of the first CPU, and the second stall parameter may be determined by multiplying the first number of stalls with a pipeline capacity value of the second CPU and a power curve parameter of the second CPU. Such multiplication may be performed to determine stall parameters for additional CPUs, and a CPU having a lowest stall parameter may be selected for assignment of the first task. If a performance mode is selected and/or if all CPUs considered for performing the task are in a same cluster, stall parameters may be determined based on multiplying a number of stalls of the first CPU when executing the task, or numbers of stalls associated with pipeline components of the first CPU when executing the task, with normalized pipeline capacities of respective CPUs, or pipeline components of the respective CPUs, and a CPU may be selected for assignment of the task without considering power curve parameters of the CPUs. In some embodiments, the method 800 may be repeated for a plurality of tasks of an application, or multiple applications, executed by the processor. For example, in some embodiments, the method 800 may be performed for a top number of tasks, such as 16 or another number, ranked by resource consumption for an application. Thus, a task may be assigned to a CPU that is least likely to encounter stalls performing the task based on a number of stalls calculated for a first CPU and normalized pipeline capacity values for the first CPU and other CPUs. Such assignment may allow tasks that require substantial front end capacity to be assigned to CPUs having substantial front end capacity, while tasks that require substantial back end capacity may be assigned to CPUs having substantial back end capacity. In particular, such assignment may allow for enhanced performance and reduced power consumption in gaming and other applications.

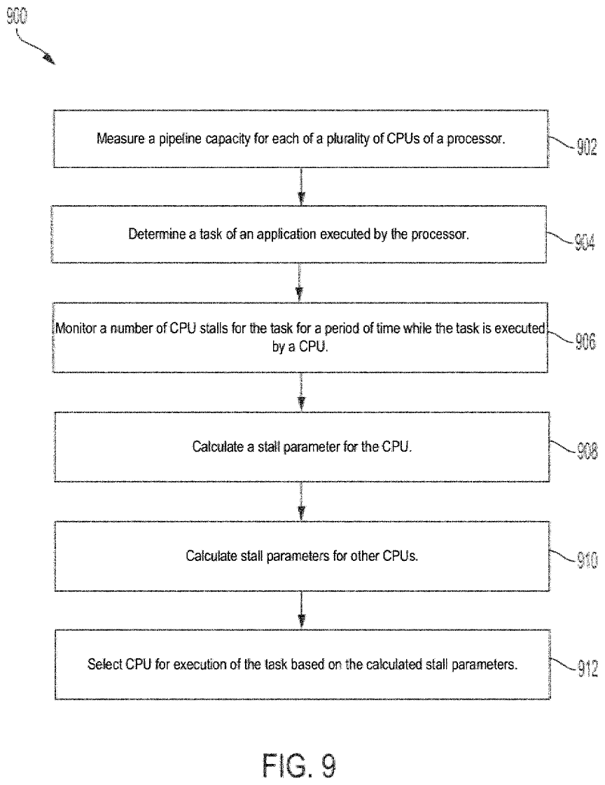

One method of micro-architecture aware task scheduling described herein is shown in FIG. 9. FIG. 9 is a flow chart illustrating an example method 900 for micro-architecture aware task scheduling. The method 900 includes, at block 902, measuring a pipeline capacity for each of a plurality of CPUs of a processor. In some embodiments, pipeline capacities may be measured for a plurality of pipeline components of each of a plurality of CPUs of a processor. To measure the pipeline capacity, the processor may run a synthetic power task routine, such as a benchmark, on one or more applicable CPUs and may measure a number of stalls that occur on each of the CPUs, or on each of the pipeline components of each of the CPUs, such as described with respect to FIG. 6. A CPU with a highest pipeline capacity, such as a CPU that encounters a lowest number of stalls when executing the synthetic power task routine, may be assigned a normalized pipeline capacity value of 1, while other CPUs may be assigned normalized pipeline capacity values based on a relationship between a number of stalls encountered by the other CPUs and the number of stalls encountered by the CPU with the highest pipeline capacity. For example, other CPUs may be assigned values representing a percentage of the pipeline capacity value of the CPU with the highest pipeline capacity, calculated by dividing a number of stalls encountered by each respective CPU during a period of time when executing the synthetic power task routine by a number of stalls encountered by the CPU with the highest pipeline capacity when executing the synthetic power task routine. In some embodiments, normalized pipeline capacity values may be calculated for each of multiple pipeline components of each CPU based on numbers of stalls encountered associated with the different pipeline components.

At block 904, a task of an application executed by the processor may be determined. For example, a task of an application executed by a processor may be assigned to an initial CPU using the process described with respect to FIG. 4, or another process. As one particular example, a processor may determine a plurality of tasks, such as a set top number of tasks, of an application, such as a gaming application, for monitoring for stalls and reassignment based on monitored stalls. In some embodiments, a counter may be used by the processor to determine a top 16 tasks of an application. Thus, block 904, and blocks 906-912, may be repeated and performed for multiple tasks of an application. In some embodiments, blocks 904-912 may be performed at runtime.

At block 906, a number of CPU stalls for the task may be monitored for a period of time while the task is executed by the CPU. For example, a PMU counter may be used to determine a number of stalls that occur while the task is executed by the CPU. The period of time may, for example, begin when the task is scheduled into the CPU and end when the task is scheduled out of the CPU. For example, the PMU counter may be read and or summed when the task is scheduled out of the CPU. If the time has not reached a threshold, such as a threshold number of seconds of monitoring execution of the task, the monitoring may be repeated on a following execution of the task until the task has been monitored for stalls for the predetermined period of time. In some embodiments, such monitoring may be performed for multiple pipeline components while the task is executed, to determine a number of stalls that occur associated with each pipeline component during the period of time. The operations of block 906 may, in some embodiments, be performed as part of the operations of block 802 of FIG. 8.

At block 908, a stall parameter for the CPU may be calculated. For example, a stall parameter for the CPU may be calculated based on the number of stalls that occur when the task is executed by the CPU and, in some embodiments, a pipeline capacity value of the CPU, as described with respect to block 802 of FIG. 8. In some embodiments, stall parameters, such as stall percentages, may be calculated for each of a plurality of pipeline components of the CPU. In some embodiments, such as when one or more CPUs of clusters different from a cluster of the CPU executing the task at block 906 are considered for transfer of the task and/or a default mode is selected for task assignment, a stall parameter may be determined based on the number(s) of stalls, the pipeline capacity value(s) of the CPU, and a power curve parameter of the CPU. Such determination may allow for assignment of the task based on both power consumption and performance. In some embodiments, such as when only CPUs of a same cluster as the CPU executing the task are considered for transfer of the task and/or a performance mode is selected for task assignment, a stall parameter, such as a stall percentage, may be determined based on the number(s) of stalls and the pipeline capacity value(s) of the CPU, without consideration of the power curve parameter of the CPU.

At block 910, stall parameters may be calculated for other CPUs of the processor. For example, stall parameters for other CPUs of the processor may be calculated based on the number of stalls that occur when the task is executed by the CPU and based on the normalized pipeline capacity values of the other CPUs, as described with respect to block 804 of FIG. 8. Such calculation may include estimation of a stall percentage value for each of the other CPUs of the processor by multiplying the number(s) of stalls encountered by the CPU executing the task at block 906 by the normalized pipeline capacities of the other CPUs, such as by multiplying the number of stalls for each pipeline component of the CPU executing the task by respective pipeline capacity values for each respective pipeline component of each of the other CPUs and summing the products for each respective CPU to determine stall parameters for each CPU. In some embodiments, stall parameters may be calculated for each of a plurality of pipeline components of the CPU. In some embodiments, such as when one or more CPUs of clusters different from a cluster of the CPU executing the task are considered for transfer of the task and/or a default mode is selected for task assignment, stall parameters for the other CPUs may be determined based on the number(s) of stalls encountered by the CPU executing the first task, the pipeline capacity values of the respective CPUs, and power curve parameters of the respective CPUs. In some embodiments, such as when only CPUs of a same cluster as the CPU executing the task are considered for transfer of the task and/or a performance mode is selected for task assignment, stall parameters may be determined based on the number(s) of stalls encountered by the CPU executing the task and the respective pipeline capacity values of the CPUs, without consideration of the power curve parameters of the CPUs. In some embodiments, stall parameters may be calculated for all other CPUs of a same cluster as the CPU executing the task, and identification of such CPUs may be obtained from a scheduler. In some embodiments, stall parameters may be calculated for CPUs in different clusters, in addition to or in place of CPUs from a same cluster as the CPU executing the task, and identification of such CPUs may be obtained from a scheduler.

At block 912, a CPU may be selected for execution of the task. For example, a CPU with a lowest stall parameter value may be selected for performing the task, and the task may be transferred to be performed by the selected CPU. Thus, a task may be transferred to another CPU of a processor based on a prediction that a number of stalls will be lower if the task is executed by the other CPU and, in some embodiments, based further on a predicted power consumption of candidate CPUs for execution of the task.

It is noted that one or more blocks (or operations) described with reference to FIGS. 4 and 8-9 may be combined with one or more blocks (or operations) described with reference to another of the figures. For example, one or more blocks (or operations) of FIG. 8 may be combined with one or more blocks (or operations) of FIG. 9. As another example, one or more blocks associated with FIG. 8 may be combined with one or more blocks associated with FIG. 4.

In one or more aspects, techniques for supporting vehicular operations may include additional aspects, such as any single aspect or any combination of aspects described below or in connection with one or more other processes or devices described elsewhere herein. In a first aspect, a method for assigning a task for execution by a processor may include calculating a first stall parameter for the task associated with a first CPU of the processor, wherein the task is assigned to the first CPU of the processor, calculating a second stall parameter for the task associated with a second CPU of the processor, and assigning the task to the second CPU based on the first stall parameter and the second stall parameter. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method may include one or more operations described herein with reference to the apparatus.

In a second aspect, in combination with the first aspect, calculating the first stall parameter comprises measuring a first number of stalls for a first time period while the task is executed by the first CPU and multiplying the first number of stalls by a first pipeline capacity of the first CPU.

In a third aspect, in combination with one or more of the first aspect or the second aspect, calculating the second stall parameter comprises multiplying the first number of stalls by a second pipeline capacity of the second CPU.

In a fourth aspect, in combination with one or more of the first aspect through the third aspect, calculating the first stall parameter further comprises multiplying a first product of the first number of stalls and the first pipeline capacity with a first power curve parameter of the first CPU and calculating the second stall parameter further comprises multiplying a second product of the first number of stalls and the second pipeline capacity with a second power curve parameter of the second CPU.

In a fifth aspect, in combination with one or more of the first aspect through the fourth aspect, measuring the first number of stalls for the first time period comprises measuring a second number of stalls associated with a front end of the first CPU and measuring a third number of stalls associated with a back end of the first CPU.

In a sixth aspect, in combination with one or more of the first aspect through the fifth aspect, the method further comprises: measuring a first pipeline capacity of the first CPU and measuring a second pipeline capacity of the second CPU, wherein calculating the second stall parameter is based on the first pipeline capacity and the second pipeline capacity.

In a seventh aspect, in combination with one or more of the first aspect through the sixth aspect, the first CPU and the second CPU are in a same cluster.

In an eighth aspect, in combination with one or more of the first aspect through the seventh aspect, the first CPU and the second CPU are in different clusters.

Components, the functional blocks, and the modules described herein with respect to FIGS. 1-4 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method for assigning a task for execution by a processor, the method comprising:
calculating a first stall parameter for the task associated with a first central processing unit (CPU) of the processor, wherein the task is assigned to the first CPU of the processor;
calculating a second stall parameter for the task associated with a second CPU of the processor; and
assigning the task to the second CPU based on the first stall parameter and the second stall parameter.

2. The method of claim 1, wherein calculating the first stall parameter comprises:
measuring a first number of stalls for a first time period while the task is executed by the first CPU; and
multiplying the first number of stalls by a first pipeline capacity of the first CPU.

3. The method of claim 2, wherein calculating the second stall parameter comprises:
multiplying the first number of stalls by a second pipeline capacity of the second CPU.

4. The method of claim 3, wherein calculating the first stall parameter further comprises multiplying a first product of the first number of stalls and the first pipeline capacity with a first power curve parameter of the first CPU, and wherein calculating the second stall parameter further comprises multiplying a second product of the first number of stalls and the second pipeline capacity with a second power curve parameter of the second CPU.

5. The method of claim 2, wherein measuring the first number of stalls for the first time period comprises:
measuring a second number of stalls associated with a front end of the first CPU; and
measuring a third number of stalls associated with a back end of the first CPU.

6. The method of claim 1, further comprising:
measuring a first pipeline capacity of the first CPU; and
measuring a second pipeline capacity of the second CPU,
wherein calculating the second stall parameter is based on the first pipeline capacity and the second pipeline capacity.

7. The method of claim 1, wherein the first CPU and the second CPU are in a same cluster.

8. The method of claim 1, wherein the first CPU and the second CPU are in different clusters.

9. An apparatus, comprising:
a memory storing processor-readable code; and
at least one processor coupled to the memory, the at least one processor configured to execute the processor-readable code to cause the at least one processor to perform operations including:
calculating a first stall parameter for a task associated with a first central processing unit (CPU) of the processor, wherein the task is assigned to the first CPU of the processor;
calculating a second stall parameter for the task associated with a second CPU of the processor; and
assigning the task to the second CPU based on the first stall parameter and the second stall parameter.

10. The apparatus of claim 9, wherein calculating the first stall parameter comprises:
measuring a first number of stalls for a first time period while the task is executed by the first CPU; and
multiplying the first number of stalls by a first pipeline capacity of the first CPU.

11. The apparatus of claim 10, wherein calculating the second stall parameter comprises:
multiplying the first number of stalls by a second pipeline capacity of the second CPU.

12. The apparatus of claim 11, wherein calculating the first stall parameter further comprises multiplying a first product of the first number of stalls and the first pipeline capacity with a first power curve parameter of the first CPU, and wherein calculating the second stall parameter further comprises multiplying a second product of the first number of stalls and the second pipeline capacity with a second power curve parameter of the second CPU.

13. The apparatus of claim 10, wherein measuring the first number of stalls for the first time period comprises:
measuring a second number of stalls associated with a front end of the first CPU; and
measuring a third number of stalls associated with a back end of the first CPU.

14. The apparatus of claim 9, wherein the at least one processor is further configured to execute the processor-readable code to cause the at least one processor to perform operations including:
measuring a first pipeline capacity of the first CPU; and
measuring a second pipeline capacity of the second CPU,
wherein calculating the second stall parameter is based on the first pipeline capacity and the second pipeline capacity.

15. The apparatus of claim 9, wherein the first CPU and the second CPU are in a same cluster.

16. The apparatus of claim 9, wherein the first CPU and the second CPU are in different clusters.

17. A non-transitory computer-readable medium storing instructions that, when executed by a processor, cause the processor to perform operations comprising:
calculating a first stall parameter for a task associated with a first central processing unit (CPU) of the processor, wherein the task is assigned to the first CPU of the processor;
calculating a second stall parameter for the task associated with a second CPU of the processor; and
assigning the task to the second CPU based on the first stall parameter and the second stall parameter.

18. The non-transitory computer-readable medium of claim 17, wherein calculating the first stall parameter comprises:
measuring a first number of stalls for a first time period while the task is executed by the first CPU; and
multiplying the first number of stalls by a first pipeline capacity of the first CPU.

19. The non-transitory computer-readable medium of claim 18, wherein calculating the second stall parameter comprises:
multiplying the first number of stalls by a second pipeline capacity of the second CPU.

20. The non-transitory computer-readable medium of claim 19, wherein calculating the first stall parameter further comprises multiplying a first product of the first number of stalls and the first pipeline capacity with a first power curve parameter of the first CPU, and wherein calculating the second stall parameter further comprises multiplying a second product of the first number of stalls and the second pipeline capacity with a second power curve parameter of the second CPU.

21-30. (canceled)
